(19) United States
(12) Patent Application Publication
(10) Pub. No.: US 2006/0248075 A1
(43) Pub. Date: Nov. 2, 2006

(54) Content search device and its method

(75) Inventors: Taishi Shimomori, Kanagawa (JP); Kohei Momosaki, Kanagawa (JP); Tatsuya Uehara, Tokyo (JP); Yasuyuki Masai, Kanagawa (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: Kabushiki Kaisha Toshiba, Tokyo (JP)

(21) Appl. No.: 11/232,973

(22) Filed: Sep. 23, 2005

(30) Foreign Application Priority Data
May 2, 2005 (JP) 2005-134679

(51) Int. Cl. G06F 17/30

(52) U.S. Cl. 707/5

(57) ABSTRACT

A content search device includes a content obtaining unit which obtains a content; an attribute information obtaining unit which obtains attribute information about the content; a search key storing unit which stores a search key and the attribute information about the content associated with the search key; a search key deciding unit which collates the obtained attribute information with the attribute information stored associated with the stored search key and decides a search key for use in search; and a search unit which searches the content by using the decided search key.

### CROSS-REFERENCE TO RELATED APPLICATIONS

This application is based upon and claims the benefit of priority from the prior Japanese Patent Application No. 2005-134679, filed on May 2, 2005; the entire contents of which are incorporated herein by reference.

### TECHINICAL FIELD

The present invention relates to a content search device for searching contents by using attribute information and its method.

### BACKGROUND OF THE INVENTION

These days, a study and development of a search device is progressing, where a search key composed of the characteristic amount obtained by analyzing a sound signal or a video signal is compared with the characteristic amount obtained by analyzing the sound signal or the video signal to be searched and the similarity of the both is calculated, thereby searching the objective sound signal or video signal for a portion similar to the search key.

In Japanese Patent Laid-Open No. 134613/2001, a user listens in or previews the sound signal or the video signal that is the extraction source of the search key and registers the search key into a search unit.

The above conventional method, however, has a problem that a user has to find every search key from the search key storing unit to specify each of the search keys.

Taking the above situation into consideration, the invention provides a content search device and its method in which a user does not have to directly specify a search key.

### BRIEF SUMMARY OF THE INVENTION

According to embodiments of the invention, a content search device includes: a content processor which obtains a content; an attribute processor which obtains attribute information about the content; a search key storing memory which stores a search key for searching for a predetermined position within the content and the attribute information about the content associated with the search key; a search key processor which collates the obtained attribute information with the stored attribute information and extracts a search key about the attribute information satisfying a predetermined collation condition; and a search processor which searches the obtained contents by using the search key.

According to the invention, a user does not have to directly specify a search key, but the search is performed by use of the search key only associated with the attribute information, thereby reducing the calculation load.

### BRIEF DESCRIPTION OF THE DRAWINGS

FIG. 1 is a block diagram showing the structure of a content search device according to the first embodiment of the invention.

FIG. 2 is a flow chart showing the operation of the first embodiment.

FIG. 3 is a view showing the constitutional example of a search key storing unit according to the first embodiment.

FIG. 4 is a view showing the constitutional example of the search key storing unit according to an embodiment.

FIG. 5 is a block diagram showing the structure of a content search device according to the second embodiment of the invention.

FIG. 6 is a flow chart showing the operation of the second embodiment.

FIG. 7 is a block diagram showing the structure of the content search device according to a variation example of the second embodiment.

FIG. 8 is a block diagram showing the structure of a content search device according to the third embodiment.

FIG. 9 is a flow chart showing the operation of the third embodiment.

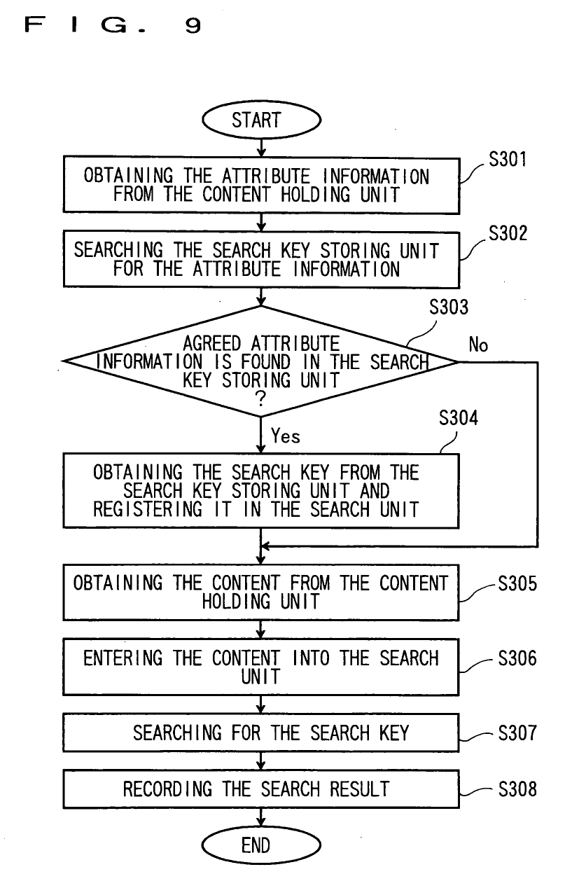

FIG. 10 is a block diagram showing the structure of the content search device according to a variation example of the third embodiment.

### DETAILED DESCRIPTION OF THE INVENTION

Hereinafter, a content search device according to the embodiments of the invention will be described referring to the drawings.

In the specification, the “content” means a program or CM broadcasted through TV, radio, satellite broadcasting, and wire broadcasting. The “attribute information” means the information indicating the quality concerned with a program for distinguishing the contents.

### First Embodiment

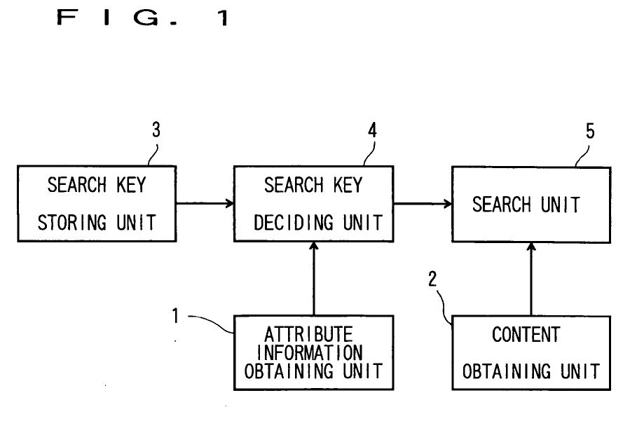

A content search device according to the first embodiment of the invention will be described according to FIG. 1 to FIG. 4.

(1) Structure of the Content Search Device

FIG. 1 is a block diagram showing the structure of the content search device according to the embodiment.

As illustrated in FIG. 1, the content search device includes an attribute information obtaining unit 1, a content obtaining unit 2, a search key storing unit 3, a search key deciding unit 4, and a search unit 5.

The attribute information obtaining unit 1 obtains the attribute information for distinguishing the attribute of the search key and supplies the attribute information to the search key deciding unit 4.

The content obtaining unit 2 obtains the content and supplies it to the search unit 5.

The search key storing unit 3 stores the attribute information and the search key associated with each other.

The search key deciding unit 4 collates the attribute information entered from the attribute information obtaining unit 1 with the attribute information of the search key stored in the search key storing unit 3 and registers the search key of the agreed attribute information into the search unit 5.

The search unit 5 searches the content entered from the content obtaining unit 2 for the registered search key.

(2) The Outline of the Operation of the Content Search Device

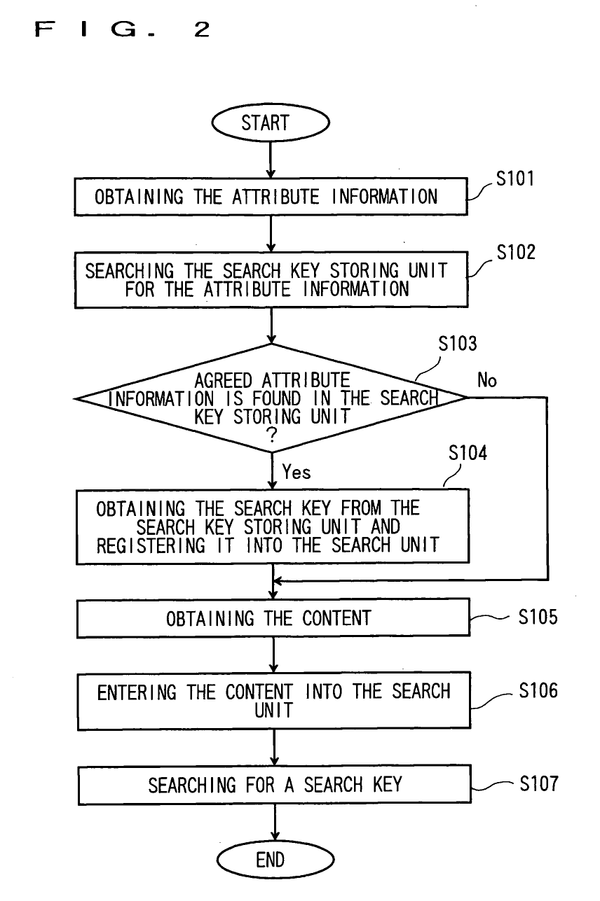

The operation of the content search device will be described by using FIG. 1 and FIG. 2.

FIG. 2 is a flow chart showing the operation of the content search device.

This operation is, for example, to set a search key from the attribute information as for a live program of a channel (for example, 1 ch). When a user switches the channel from 1 ch to 3 ch and the search key is detected also in the previous 1 ch during listening/watching the content of 3 ch, a competing program is to be monitored and to notify the current 3 ch that a hit is found also in the 1 ch.

At first, the attribute information obtaining unit 1 obtains the attribute information and supplies it to the search key deciding unit 4 (Step S101).

The search key deciding unit 4 searches the search key storing unit 3 for the attribute information which agrees with the entered attribute information (Step S102).

As a result of the search, the search keys respectively associated with all the agreed attribute information are obtained from the search key storing unit 3 and registered into the search unit 5 (Step S103 and S104).

The content obtaining unit 2 obtains a content (Step S105) and supplies it to the search unit 5 (Step S106).

The search unit 5 searches the contents for a registered search key (Step S107).

(3) The Detailed Operation of the Content Search Device

A more particular and concrete operation of the content search device will be described.

At first, the attribute information obtaining unit 1 obtains the attribute information of the EPG program. Here, a user may enter the attribute information. The attribute information obtaining unit 1 extracts a program title from the obtained attribute information and supplies it to the search key deciding unit 4.

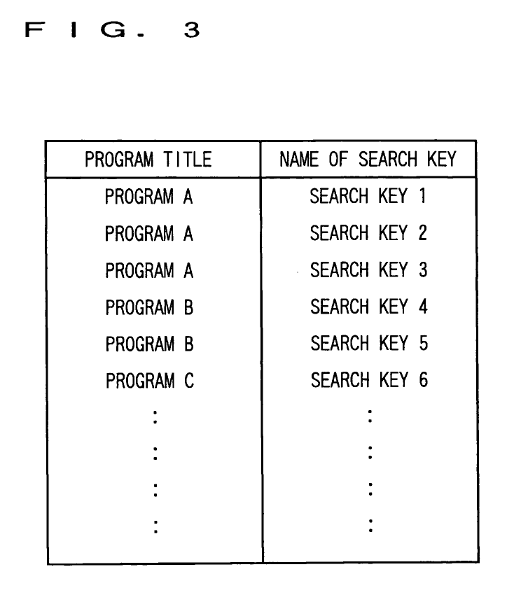

The search key deciding unit 4 collates the program title with the program title of the search key storing unit 3. Assume that the search key storing unit 3 is formed as illustrated in FIG. 3. When the program title entered into the search key deciding unit 4 is “program A”, “search key 1”, “search key 2”, and “search key 3” corresponding to the “program A” of the search key storing unit 3 are registered into the search unit 5.

When the registered search key is an audio search key that is the characteristic amount of an audio signal, the content obtaining unit 2 supplies the audio signal of the content including the obtained audio information to the search unit 5. The search unit 5 analyzes the audio signal entered from the content obtaining unit 2 and searches for a portion similar to the registered audio search key.

When the search key is a character text, the search unit 5 searches for the registered character text by using the audio signal entered from the content obtaining unit 2 through voice recognition. As a method of the voice recognition, for example, every existing method may be used, for example, such as the voice recognition by the HMM method described in non-patent article 1 (“Spoken Language Processing”, Prentice Hall PTR, ISBN 0-13-022616-5).

When the registered search key is a video search key that is the characteristic amount of the video signal, the content obtaining unit 2 supplies the video signal of the content including the obtained video information to the search unit 5. The search unit 5 analyzes the video signal entered from the content obtaining unit 2 and searches for a portion similar to the registered video search key.

(4) Variation Example of the Operation of the Content Search Device

When the attribute information obtaining unit 1 extracts the attribute information, assume that a user extracts the information after grouping it in every combination of program title and day of the week, of the attribute information obtained by the attribute information obtaining unit 1 and supplies it to the search key deciding unit 4. Here, a user may specify the program title and the day of the week.

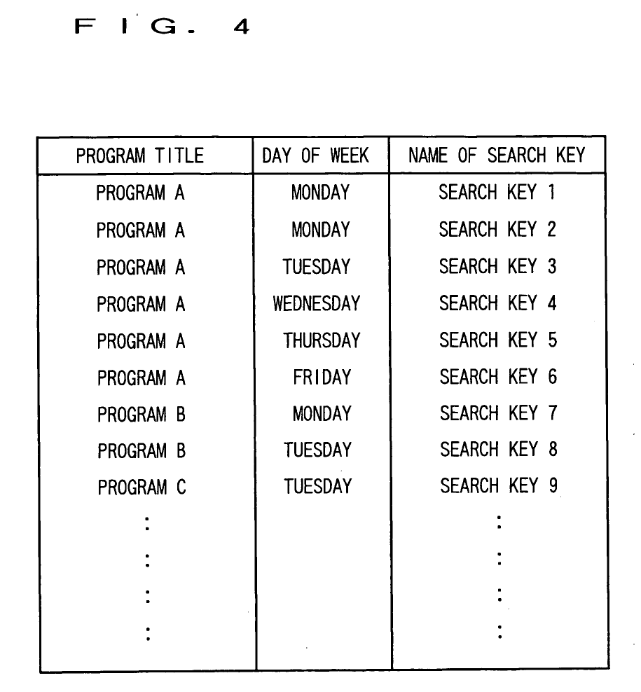

The search key deciding unit 4 collates the grouped combination of the program title and the day of the week with the combination of the program title and the day of the week grouped by the search key storing unit 3. Assume that the search key storing unit 3 is formed as illustrated in FIG. 4. When the combination of the program title and the day of the week entered into the search key deciding unit 4 is “program A” and “Monday”, the “search key 1” and the “search key 2” that are the search keys corresponding to the “program A” and the “Monday” in the search key storing unit 3 are registered into the search unit 5.

Here, the all-agreed grouped attribute information may be selected or a group having the greatest number of the agreed attribute information may be selected.

(5) Effect of the Embodiment

According to this embodiment, a user does not have to specify a search key directly but he or she has only to specify the attribute of a program, and the search only by use of the search key associated with the attribute information enables a decrease in calculation load.

### Second Embodiment

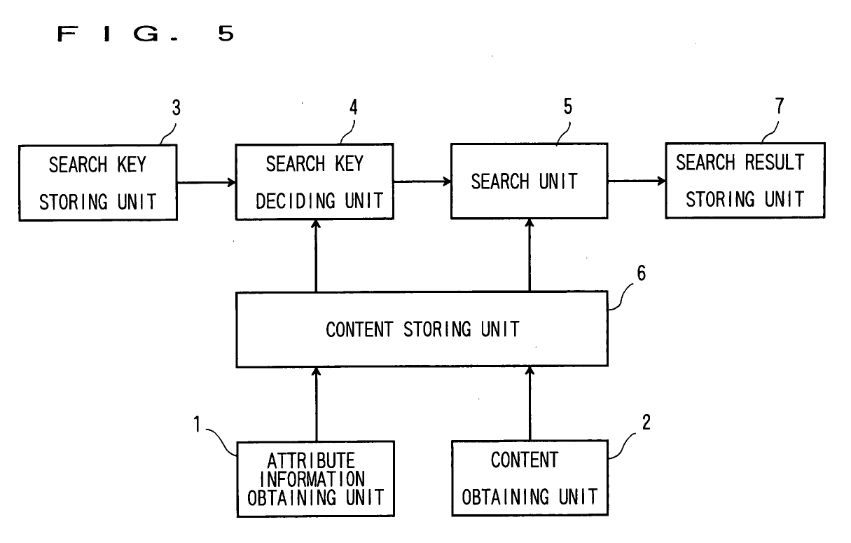

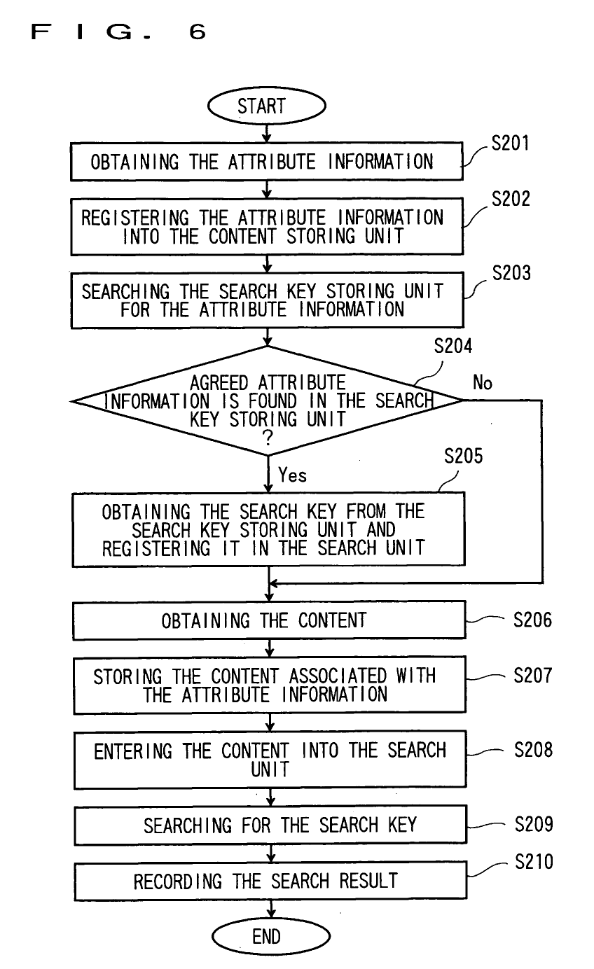

The content search device according to the second embodiment of the invention will be described according to FIG. 5 and FIG. 6.

(1) Structure of the Content Search Device

FIG. 5 is a block diagram showing the structure of the content search device according to the embodiment.

As illustrated in FIG. 5, the content search device includes an attribute information obtaining unit 1, a content obtaining unit 2, a search key storing unit 3, a search key deciding unit 4, a search unit 5, a content storing unit 6, and a search result storing unit 7.

The attribute information obtaining unit 1 obtains the attribute information for distinguishing the attribute of the search key and supplies the attribute information to the content storing unit 6.

The content obtaining unit 2 obtains a content and supplies it to the content storing unit 6.

The content storing unit 6 stores the attribute information entered from the attribute information obtaining unit 1 and the content obtained from the content obtaining unit 2 associated with each other, supplies the attribute information to the search key deciding unit 4, and supplies the content to the search unit 5.

The search key storing unit 3 stores the attribute information and the search key associated with each other.

The search key deciding unit 4 collates the attribute information entered from the content storing unit 6 with the attribute information of the search key stored in the search key storing unit 3 and registers the search key of the agreed attribute information into the search unit 5.

The search unit 5 searches the content entered from the content storing unit 6 for the registered search key.

The search result storing unit 7 records the search result associated with the recorded content.

(2) The Outline of the Operation of the Content Search Device

The operation of the content search device according to the embodiment will be described by using FIG. 5 and FIG. 6.

According to the operation, for example, the attribute information is obtained from the EPG (Electronic Program Guide) at a time of programming to record a program and a search key corresponding to the attribute information is set. At a recording time, the search key is detected from the contents and the search result is recorded. This operation is to skip to a search position during listening and watching the recorded content.

FIG. 6 is a flow chart showing the operation of the content search device according to the embodiment.

At first, the attribute information obtaining unit 1 obtains the attribute information (Step S201) and supplies it to the content storing unit 6.

The content storing unit 6 stores the attribute information (Step S202) and supplies the attribute information to the search key deciding unit.

The search key deciding unit 4 searches the search key storing unit 3 for the attribute information that agrees with the entered attribute information (Steps S203 and S204).

As a result of the search, the search keys associated with the attribute information, of all the agreed attribute information, are obtained from the search key storing unit 3 and registered into the search unit 5 (Step S205).

The content obtaining unit 2 obtains the content (Step S206) and supplies it to the content storing unit 6.

The content storing unit 6 stores each content associated with the stored attribute information (Step S207), and supplies it to the search unit 5 (Step S208).

The search unit 5 searches the content for the registered search key (Step S209).

The search result storing unit 7 stores the search result together with each search position of the contents (Step S210).

(3) The Detailed Operation of the Content Search Device

A more particular and concrete operation of the content search device will be described.

At first, the attribute information obtaining unit 1 obtains the attribute information about a program of EPG. Here, a user may enter the attribute information. The attribute information obtaining unit 1 extracts the program title from the obtained attribute information and supplies it to the content storing unit 6.

The content storing unit 6 stores the program title and supplies the program title to the search key deciding unit 4.

The search key deciding unit 4 collates the program title with the program title of the search key storing unit 3. Assume that the search key storing unit 3 is formed as illustrated in FIG. 3. When the program title entered into the search key deciding unit 4 is “program A”, “search key 1”, “search key 2”, and “search key 3” that are the search keys corresponding to the “program A”, in the search key storing unit 3, are registered into the search unit 5.

The content obtaining unit 2 supplies the obtained content to the content storing unit 6. The content storing unit 6 stores the program content associated with the stored program title.

When the registered search key is an audio search key that is the characteristic amount of an audio signal, the content storing unit 6 supplies the audio signal of the program content to the search unit 5. The search unit 5 analyzes the audio signal entered from the content storing unit 6 and searches for a portion similar to the registered audio search key.

When the search key is a character text, the search unit 5 searches for the character text registered by using the audio signal entered from the content obtaining unit 2 through voice recognition.

When the registered search key is a video search key that is the characteristic amount of a video signal, the content storing unit 6 supplies the video signal of the contents including the obtained video information to the search unit 5. The search unit 5 analyzes the video signal entered from the content storing unit 6 and searches for a portion similar to the registered video search key.

(4) Variation Example of the Operation of the Content Search Device

When the attribute information obtaining unit 1 extracts the attribute information, assume that a user extracts the information after grouping it in every combination of program title and day of the week, of the attribute information obtained by the attribute information obtaining unit 1 and supplies it to the search key deciding unit 4. Here, a user may specify the program title and the day of the week.

The search key deciding unit 4 collates the grouped combination of the program title and the day of the week with the grouped combination of the program title and the day of the week within the search key storing unit 3. Assume that the search key storing unit 3 is formed as illustrated in FIG. 4. When the combination of the program title and the day of the week entered into the search key deciding unit 4 is “program A” and “Monday”, “search key 1” and “search key 2” that are the search keys corresponding to the “program A” and the “Monday” within the search key storing unit 3 are registered into the search unit 5.

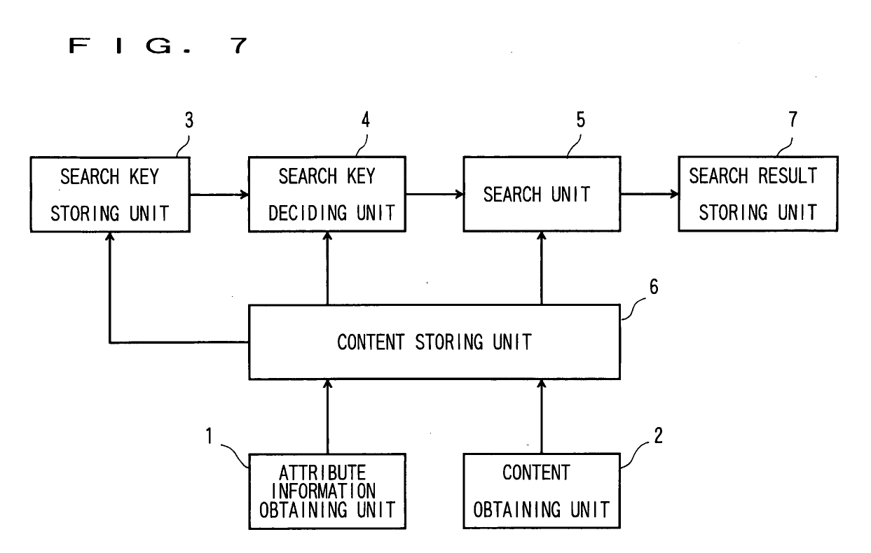

As illustrated in a block diagram of FIG. 7, when registering the search key into the search key storing unit 3, the search key may be created during reproducing the content within the content storing unit 6, and the created search key may be registered into the search key storing unit 3 associated with the program title of the content of the created search key stored in the content storing unit 6.

(5) Effect of the Embodiment

According to this embodiment, a user does not have to specify a search key directly, but the specification of only the attribute of a program helps to search the content while recording it. Only the search key associated with the attribute information can be used to search the content, thereby reducing the calculation load.

### Third Embodiment

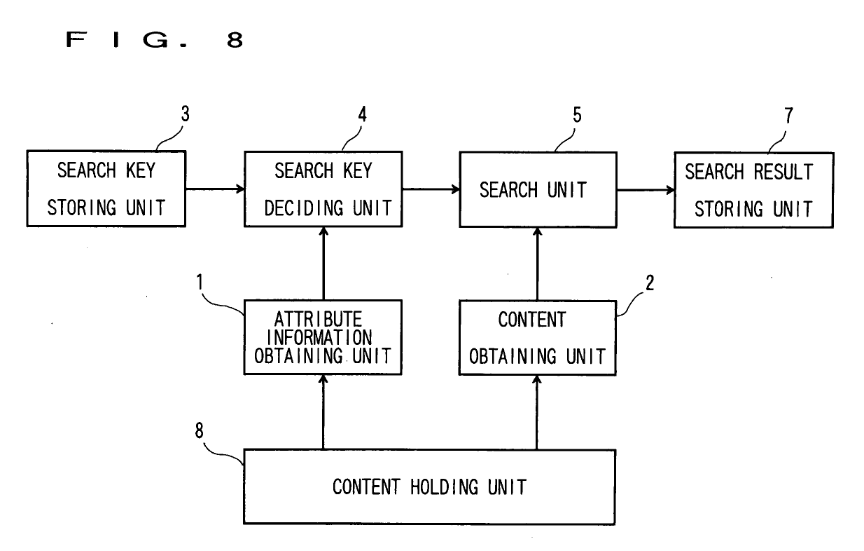

The content search device according to the third embodiment of the invention will be described with reference to FIG. 7 and FIG. 8.

(1) Structure of the Content Search Device

FIG. 7 is a block diagram showing the structure of the content search device according to the embodiment.

As illustrated in FIG. 7, the content search device in the invention includes an attribute information obtaining unit 1, a content obtaining unit 2, a search key storing unit 3, a search key deciding unit 4, a search unit 5, a content holding unit 8, and a search result storing unit 7.

The attribute information obtaining unit 1 obtains the attribute information for distinguishing the attribute of a search key from the content holding unit 8 and supplies it to the search key deciding unit 4.

The content obtaining unit 2 enters the content from the content holding unit 8 and supplies it to the search unit 5.

The content holding unit 8 stores the attribute information and the content associated with each other, supplies the attribute information to the attribute information obtaining unit 1, and supplies the content to the content obtaining unit 2.

The search key storing unit 3 stores the attribute information and the search key associated with each other.

The search key deciding unit 4 collates the attribute information entered from the attribute information obtaining unit 1 with the attribute information of the search key stored into the search key storing unit 3 and registers the search key of the agreed attribute information into the search unit 5.

The search unit 5 searches for the registered search key from the content entered from the content obtaining unit 2.

The search result storing unit 7 stores the search result and the stored content associated with each other.

(2) The Outline of the Operation of the Content Search Device

The operation of the content search device according to the embodiment will be described by using FIG. 7 and FIG. 8.

A search key corresponding to the attribute information associated with the content is set before this operation or reproducing a plurality of contents. The search key is detected from the contents at a reproducing time and the search result is stored. One portion of the respective contents is extracted from the search result and a play list is created.

FIG. 8 is a flow chart showing the operation of the content search device according to the embodiment.

At first, the content holding unit 8 supplies the attribute information of the content to supply to the content obtaining unit 2, to attribute information obtaining unit 1 (Step S301).

The attribute information obtaining unit 1 supplies the entered attribute information to the search key deciding unit.

The search key deciding unit 4 searches the search key storing unit 3 for the attribute information which agrees with the entered attribute information (Steps S302 and S303). As a result of the search, the search key associated with the attribute information is obtained from the search key storing unit 3, as for all the agreed attribute information, and registered into the search unit 5 (Step S304).

The content obtaining unit 2 obtains the content from the content holding unit 8 (Step S305), and supplies it to the search unit 5 (Step S306).

The search unit 5 searches the content for the registered search key (Step S307).

The search result storing unit 7 records the search result together with the search position of the content (Step S308).

(3) Detailed Operation of the Content Search Device

A more particular and concrete operation of the content search device will be described.

At first, the attribute information obtaining unit 1 obtains the attribute information of the content to be supplied from the content holding unit 8 to the content obtaining unit 2. The attribute information obtaining unit 1 extracts the program title from the obtained attribute information and supplies it to the search key deciding unit 4.

The search key deciding unit 4 collates the program title with the program title of the search key storing unit 3. Assume that the search key storing unit 3 is formed as illustrated in FIG. 3. When the program title entered into the search key deciding unit 4 is “program A”, “search key 1”, “search key 2”, and “search key 3” that are the search keys corresponding to the “program A” within the search key storing unit 3 are registered into the search unit 5.

The content holding unit 8 supplies the content to the content obtaining unit 2.

When the registered search key is an audio search key that is the characteristic amount of an audio signal, the content storing unit 6 supplies the audio signal of the program content to the search unit 5. The search unit 5 analyzes the audio signal entered from the content obtaining unit 2 and searches for a portion similar to the registered audio search key.

When the search key is a character text, the search unit 5 searches for the registered character text through voice recognition by using the audio signal entered from the content obtaining unit 2.

When the registered search key is a video search key that is the characteristic amount of a video signal, the content storing unit 6 supplies the video signal of the program content to the search unit 5. The search unit 5 analyzes the video signal entered from the content obtaining unit 2 and searches for a portion similar to the registered video search key.

(4) Variation Example of the Operation of the Content Search Device

When the attribute information obtaining unit 1 extracts the attribute information, assume that a user extracts the information after grouping it in every combination of program title and day of the week, of the attribute information obtained by the attribute information obtaining unit 1 and supplies it to the search key deciding unit 4. Here, a user may specify the program title and the day of the week.

The search key deciding unit 4 collates the grouped combination of the program title and the day of the week with the grouped combination of the program title and the day of the week within the search key storing unit 3. Assume that the search key storing unit 3 is formed as illustrated in FIG. 4. When the combination of the program title and the day of the week entered into the search key deciding unit 4 is “program A” and “Monday”, “search key 1” and the “search key 2” that are the search keys corresponding to the “program A” and the “Monday” within the search key storing unit 3 are registered into the search unit 5.

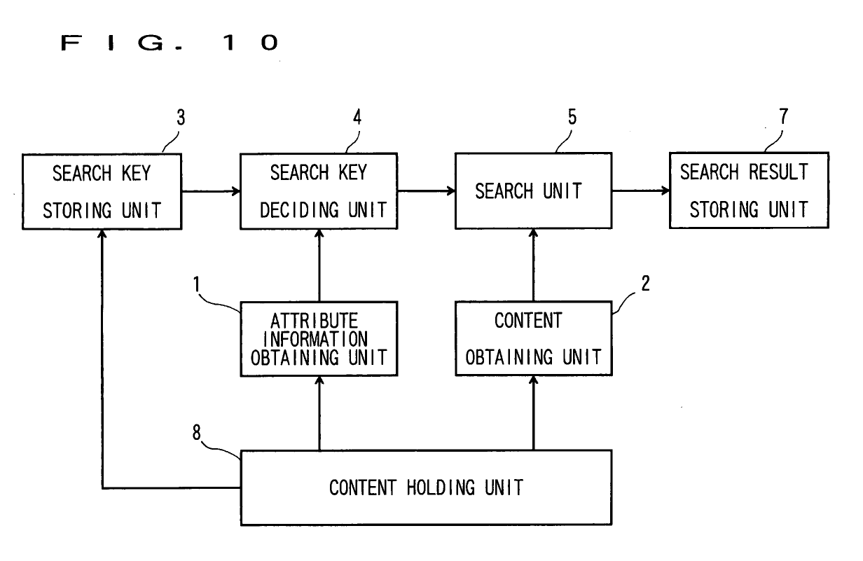

As illustrated in the block diagram of FIG. 10, when registering the search key into the search key storing unit 3, a search key may be created during reproducing the content within the content holding unit 8, the created search key may be registered into the search key storing unit 3 associated with the program title of the content of the created search key stored in the content holding unit 8.

(5) Effect of the Embodiment

According to this embodiment, a user does not have to specify a search key directly, but only the specification of a program content helps to search the content while reproducing the content. Only the search key associated with the attribute information can be used to search the content, thereby reducing the calculation load.

[Variation Example]

The invention is not restricted to the above mentioned embodiments, but also various modifications may be added to the components in the practical stage without departing from the spirit of the invention.

Various inventions may be formed by a proper combination of the several components disclosed in the above embodiments.

For example, some of the components may be deleted from the whole components shown in the embodiments. Further, the components in the different embodiments may be properly combined with each other.

### INDUSTRIAL APPLICABILITY

When a user watches or listens to the recorded content after recording a content such as a program into a recorder such as a hard disk recorder and a DVD recorder, the content search device can search a desired program easily.

What is claimed is:

1. A content search device comprising:
a content processor which obtains a content;
an attribute processor which obtains attribute information about the content;
a search key memory which stores a search key for searching for a predetermined position within the content and the attribute information about the content associated with the search key;
a search key processor which collates the obtained attribute information with the stored attribute information and extracts a search key about the attribute information satisfying a predetermined collation condition; and
a search processor which searches the obtained content by using the search key.

2. The content search device according to claim 1, comprising:
a content memory which stores the content and the attribute information associated with each other; and
a search result memory which stores a search result obtained in the search processor, associated with the stored content.

3. The content search device according to claim 1, comprising:
a content holding processor which holds the content and the attribute information about the content associated with each other; and
a search result memory which stores the search result obtained in the search processor, associated with the stored content, in which the content processor obtains the content from the content holding processor, and
the attribute processor obtains the attribute information about the content from the content holding processor.

4. The content search device according to claim 1, in which
the attribute information is at least one of program title, program category, a day of the week, time, date, program channel, program corner, and cut scene, or one portion of a program title.

5. The content search device according to claim 1, in which
a user specifies a plurality of attribute information from the attribute information stored into the search key storing memory, and
the collation condition is satisfied when the several obtained attribute information agrees with the several attribute information stored and specified.

6. The content search device according to claim 1, in which
the several attribute information stored into the search key storing memory is grouped and stored, and
the several obtained attribute information is compared with the several attribute information stored and grouped, and as a result of the comparison, when the several obtained attribute information agrees with a group having the largest number of the agreed attribute information, the collation condition is satisfied.

7. The content search device according to claim 1, in which
the attribute processor obtains the attribute information about the content from EPG.

8. The content search device according to claim 1, in which
the attribute processor obtains the attribute information specified by a user.

9. The content search device according to claim 1, in which
the search key memory registers a search key with the attribute information specified by a user.

10. The content search device according to claim 1, in which
the search key is an audio search key composed of an audio characteristic amount, and
the search processor searches for a portion where the search key is similar to an audio signal of the content.

11. The content search device according to claim 1, in which
the search key is a character text, and
after recognizing the sound of the content, the search processor searches the content from the sound recognized portion by using the search key.

12. The content search device according to claim 1, in which
the search key is a video search key composed of a video characteristic amount, and
the search processor searches for a portion similar to the video signal of the content.

13. The content search device according to claim 1, in which
the search processor determines the upper limit of the number of registered search keys.

14. A content search method comprising:
obtaining a content;
obtaining attribute information about the content;
storing a search key for searching for a predetermined position within the content as well as the attribute information about the content associated with the search key;
collating the obtained attribute information with the stored attribute information and extracting a search key about the attribute information satisfying a predetermined collation condition; and
searching the obtained content by using the search key.

15. A program product for a content search method, the program product comprising instructions of;
a content obtaining function of obtaining a content;
an attribute information obtaining function of obtaining attribute information about the content;
a search key storing function of storing a search key for searching for a predetermined position within the content as well as the attribute information about the content associated with the search key;
a search key deciding function of collating the obtained attribute information with the stored attribute information and extracting a search key about the attribute information satisfying a predetermined collation condition; and
a search function of searching the obtained content by using the decided search key.
